(19) United States
(12) Patent Application Publication
(10) Pub. No.: US 2026/0103946 A1
(43) Pub. Date: Apr. 16, 2026

(54) Door operator capable of manual operations

(71) Applicant: Chung Hsien HSIEH, New Taipei City (TW)

(72) Inventor: Chung Hsien HSIEH, New Taipei City (TW)

(21) Appl. No.: 19/010,282

(22) Filed: Jan. 6, 2025

(30) Foreign Application Priority Data
Oct. 16, 2024 (TW) 113139280

(51) Int. Cl. E05F 15/668; E05F 11/50

(52) U.S. Cl. CPC E06B 9/74; E05F 15/668; E05Y 2201/408; E05Y 2201/656; E05Y 2400/20; E05Y 2400/36

(57) ABSTRACT

A door operator capable of manual operations includes an output unit, a drive unit, a transmission unit, a brake unit, and a manual chain unit. The drive unit is disposed between the transmission unit and the brake unit. The output unit is disposed on a first side of the drive unit, the transmission unit and the brake unit. The manual chain unit is disposed on a second side of the drive unit, the transmission unit, and the brake unit that is opposite to the first side. During a manual operation mode, the brake unit provides a brake force on the drive unit and the manual chain unit is configured to generate rotational inertia, and the rotational inertia is transferred to the output unit via the brake unit, the drive unit and the transmission unit.

### FIELD OF INVENTION

The present disclosure relates to a door operating system, and more particularly to a door operator capable of manual operations.

### BACKGROUND

Although the conventional door operating systems currently used for sectional doors usually have multiple functions such as an electric operation and a manual operation. However, when encountering an emergency situation such as power outage or malfunction, it is still necessary to first combine additional components with the door operator for a manual operation so as to manually move the door.

However, when the above-mentioned emergency situation is relieved, once the door operator is switched to the electric operation without removing the additional components for the manual operation, it may cause injury to the operator or damage to the system, thereby increasing the possibility of an accident.

### SUMMARY

Accordingly, the present invention provides a door operator capable of manual operations, comprising an output unit, a drive unit, a transmission unit, a brake unit, and a manual chain unit. The drive unit is disposed between the transmission unit and the brake unit, the output unit is disposed on a first side of the drive unit, the transmission unit, and the brake unit, and the manual chain unit is disposed on a second side of the drive unit, the transmission unit, and the brake unit that is opposite to the first side. During a manual operation mode, the brake unit provides a brake force on the drive unit and the manual chain unit is configured to generate rotational inertia, and the rotational inertia is transferred to the output unit via the brake unit, the drive unit and the transmission unit.

In one embodiment, during an electric operation mode, the brake unit is powered so as to release the brake force on the drive unit, and the drive unit is configured to generate another rotational inertia, and another rotational inertia is transferred to the output unit via the transmission unit.

In one embodiment, the door operator further comprises a rotation-detecting unit, wherein the rotation-detecting unit is configured to connect the output unit via a plurality of gears to detect whether the output unit rotates.

In one embodiment, the rotation-detecting unit comprises a sensing device, and the sensing device comprises a sensing element for detecting rotation.

In one embodiment, the sensing element is an optical encoder, a magnetic induction encoder, a mechanical limit structure cooperating with a photoelectric switch, or a Hall effect sensor.

In one embodiment, the brake unit is an electromagnetic brake unit.

In one embodiment, the electromagnetic brake unit comprises a brake disc, an electromagnet shaft, an iron plate, an electromagnet, an annular spring, a wave washer, a first brake lining and an electromagnet mounting bracket. The wave washer is disposed around the electromagnet shaft, and the first brake lining is adhered to a surface of the brake disc facing the magnet disk. During the manual operation mode, the electromagnet of the brake unit is under power outage or is not powered so that the magnetic disc abuts the brake disc and the first brake lining, thereby providing a first brake force at an interface between the brake unit and the drive unit so that the rotational inertia is transferred to the output unit via the brake unit, the drive unit and the transmission unit.

In one embodiment, during the electric operation mode, the electromagnet of the brake unit is powered so as to separate from the adjacent first brake lining and release the first brake force on the drive unit.

In one embodiment, during the electric operation mode, a gap is formed between the magnet disk of the electromagnetic brake unit and the first brake lining.

In one embodiment, the brake unit further comprises a gear and a second brake lining, and the second brake lining is disposed between the gear and the electromagnet mounting bracket and is adhered to the gear, thereby providing a second brake force at an interface between the gear and the electromagnet mounting bracket.

When the door operator capable of manual operations of the present invention encounters an emergency situation, a door can be immediately move through a manual operating module, without the need for additional operating steps or component settings. Since there is no need for additional operating steps or component settings for manual operations, so the door operator capable of manual operations of the present invention can immediately and directly switch from the manual operation mode to the electric operation mode without any problem when the emergency situation is resolved without causing injuries to operators or damage to the system, thereby avoiding accidents and improving the operating efficiency of the door operator.

### BRIEF DESCRIPTION OF DRAWINGS

To explain in detail the technical schemes of the embodiments or existing techniques, drawings that are used to illustrate the embodiments or existing techniques are provided. The illustrated embodiments are just a portion of those of the present disclosure. It is easy for any person having ordinary skill in the art to obtain other drawings without labor for inventiveness.

FIG. 1 shows a schematic diagram of a door operator capable of manual operations according to an embodiment of the present invention.

FIG. 2 shows a perspective schematic view of the door operator capable of manual operations of FIG. 1 from one angle of the present invention.

FIG. 3 shows a perspective view of the door operator capable of manual operations of FIG. 1 from another angle of the present invention.

FIG. 4 shows a schematic side view of the door operator capable of manual operations of FIG. 2 of the present invention.

FIG. 5 shows another schematic side view of the door operator capable of manual operations of FIG. 2 of the present invention.

FIG. 6 shows a system schematic diagram of a door operator capable of manual operations according to an embodiment of the present invention;

FIG. 7 shows a schematic diagram of the door operator capable of manual operations during an electric operation mode according to an embodiment of the present invention;

FIG. 8 shows a schematic diagram of the door operator capable of manual operations during a manual operation mode according to an embodiment of the present invention.

### DETAILED DESCRIPTION

Before a door operator of the present invention is described in detail in embodiments, it should be noted that in the following description, similar components will be designated by the same reference numerals. Furthermore, in order to clearly illustrate the main components and operating mechanism of the door operator capable of manual operations of the present invention, the casing and the frame used to cover and/or fix the door operator will be omitted in the drawings. Furthermore, the drawings of the present invention are for illustrative purposes only, they are not necessarily drawn to scale, and not all details are necessarily shown in the drawings.

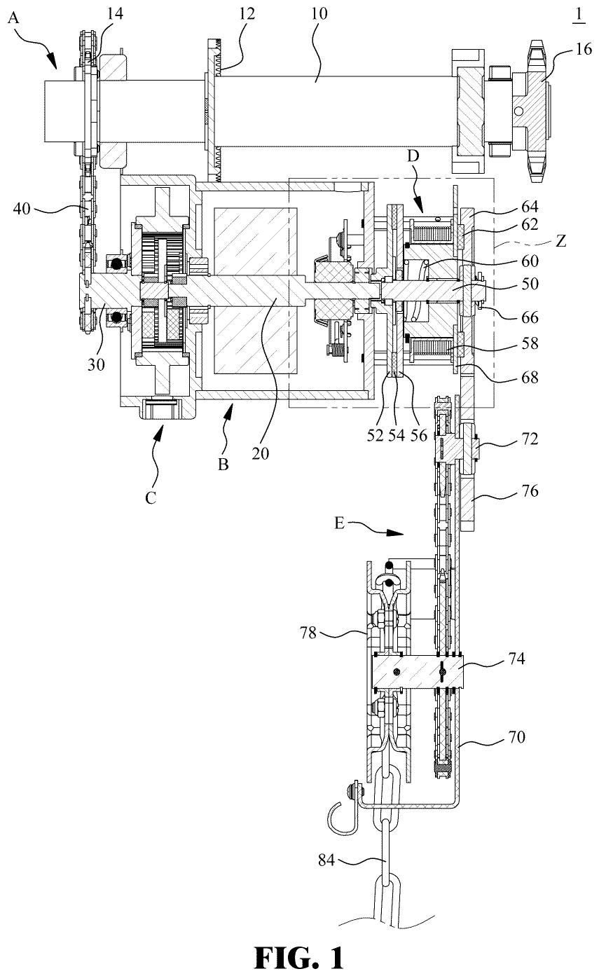

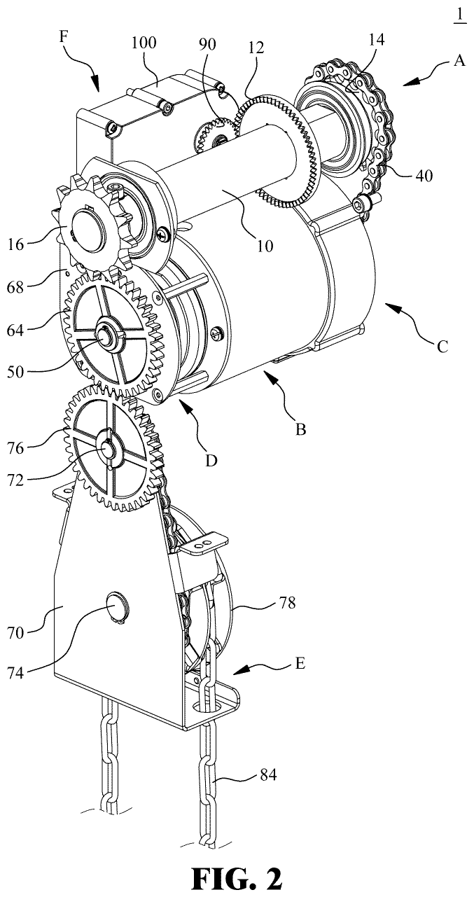

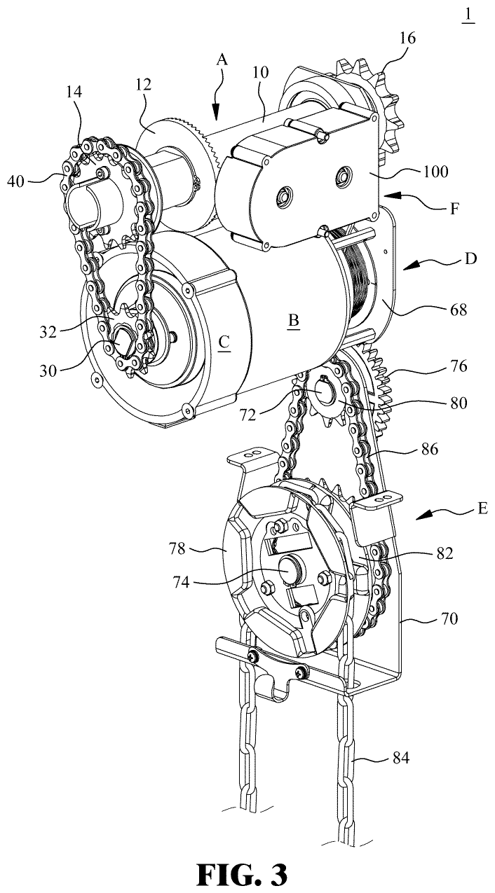

Referring to FIG. 1, FIG. 2 and FIG. 3 at the same time. FIG. 1 shows a schematic diagram of a door operator 1 capable of manual operations according to an embodiment of the present invention. FIG. 2 and FIG. 3 show perspective schematic views of the door operator capable of manual operations of FIG. 1 from two different angles of the present invention.

As shown in FIGS. 1-3, the door operator 1 of the present embodiment mainly comprises an output unit A, a drive unit B, a transmission unit C, a brake unit D, a manual chain unit E and a rotation-detecting unit F (please see FIG. 2 and FIG. 3). FIG. 1 shows a schematic cross-sectional view of the door operator 1. FIG. 2 shows a perspective view of the door operator 1 of FIG. 1 from an angle along the brake unit D toward the transmission unit C. FIG. 3 shows a perspective view of the door operator 1 of FIG. 1 from another angle along the transmission unit C toward the brake unit D.

The door operator 1 according to the present invention will be described in detail below with reference to FIGS. 1 to 3. The drive unit B is disposed between the transmission unit C and the brake unit D, and the output unit A is disposed on a first side of the drive unit B, the transmission unit C and the brake unit D. The manual chain unit E is disposed on a second side of the drive unit B, the transmission unit C and the brake unit D that is opposite to the first side. In the present embodiment, the first side is, for example, an upper side of the drive unit B, the transmission unit C, and the brake unit D, and the second side is, for example, a lower side of the drive unit B, the transmission unit C, and the brake unit D, but are not limited thereto.

As shown in FIGS. 1 to 3, the output unit A comprises an output shaft 10, a gear 12 and a sprocket 14 are set on the output shaft 10 at a predetermined position, and one end of the output shaft 10 is provided with a sprocket 16. The output shaft 10 can be directly coupled to other driving devices (not shown) to move a door (not shown). Moreover, the sprocket 16 can be further connected to a chain (not shown) to drive another driving shaft (not shown) through the chain (not shown) connected to the sprocket 16 when the output shaft 10 rotates, thereby achieving the purpose of moving the door (not shown).

As shown in FIGS. 1 to 3, the drive unit B comprises a driving shaft 20 that passes through the drive unit B. One end of the driving shaft 20 abuts the transmission unit C, and the other end of the driving shaft 20 physically contacts a portion of the brake unit D. In one embodiment, the drive unit B is, for example, a motor, and the driving shaft 20 is, for example, a motor shaft.

As shown in FIGS. 1 to 3, the transmission unit C comprises a rotating shaft 30, and a sprocket 32 is set on one end of the rotating shaft 30 protruding from the transmission unit C. The sprocket 32 and the sprocket 14 of the output unit A are connected through a chain 40. In one embodiment, the transmission unit C is, for example, a gearbox having a plurality of transmission gears (not shown).

As shown in FIGS. 1 to 3, the brake unit D, for example, is an electromagnetic brake unit, mainly comprising a brake disc 52, an electromagnet shaft 50, an iron plate 56, an electromagnet 58, an annular spring 60 and an electromagnet mounting bracket 68. The electromagnet shaft 50 passes through the brake disc 52 but does not contact the driving shaft 20 of the drive unit B. The brake unit D further comprises a gear 64 and a wave washer 66. The gear 64 is disposed on a surface of the electromagnet mounting bracket 68 where the electromagnet 58 is not disposed. The wave washer 66 is disposed around the electromagnet shaft 50, and a brake force between a brake lining 62 and the electromagnet mounting bracket 68 can be adjusted by rotating the wave washer 66. In addition, the brake unit D further comprises two brake linings 54 and 62. The brake lining 54 is adhered to a surface of the brake disc 52 facing the iron plate 56, and the brake lining 62 is disposed between the gear 64 and the electromagnet mounting bracket 68 and adhered to the gear 64. The brake disc 52 physically contacts one end of the driving shaft 20 of the drive unit B so as to rotate together with the driving shaft 20.

As shown in FIGS. 1 to 3, the manual chain unit E comprises a frame 70, two rotating shafts 72 and 74, a gear 76, a rotary disc 78, two sprockets 80 and 82 (see FIG. 3), and a manual chain 84 and a chain 86. The two sprockets 80 and 82 and the gear 76 are respectively disposed on two opposite surfaces of the frame 70. The rotating shaft 72 is arranged to pass through the frame 70, and the sprocket 80 and the gear 76 are arranged at both ends of the rotating shaft 72. The rotating shaft 74 is disposed to pass through the frame 70 and the rotary disc 78. The sprockets 80 and 82 are disposed on the frame 70 and connected through the chain 86. The gear 76 engages the gear 64 of the brake unit D, and the manual chain 84 surrounds and is disposed on the rotary disc 78. During a manual operation, an operator (not shown) can pull the manual chain 84 along one direction (not shown) which is clockwise or counterclockwise to rotate the rotary disc 78. Rotation of the rotary disc 78 drives the sprocket 82 to rotate, and rotation of the sprocket 82 drives the chain 86 to rotate, thereby resulting in rotations of the sprocket 80 and the gear 72.

As shown in FIGS. 1 to 3, the rotation-detecting unit F comprises a sensing device 100 and a gear 90 (see FIG. 2). The sensing device 100 comprises a sensing element (not shown) for detecting rotation. The sensing element is, for example, an optical encoder, a magnetic induction encoder, a mechanical limit structure cooperating with a photoelectric switch, or a Hall effect sensor. The gear 90 is disposed on a surface adjacent to the sensing device 100 and engages the gear 12 of the output unit A, thereby achieving the purpose of detecting a rotational state of the door operator 1 of the present invention.

In the present embodiment, an electric operation of the door operator 1 of the present invention can be completed through the cooperation of the output unit A, the drive unit B and the transmission unit C. In another embodiment, the manual operation of the door operator 1 of the present invention is further achieved by the brake unit D and the manual chain unit E cooperating with the operation of the output unit A, the drive unit B and the transmission unit C. In an electric operation mode of the door operator 1, the drive unit B is powered and the power is output through the transmission unit C to drive the output shaft 10 of the output unit A through the chain 40 to move the door. Meanwhile, the electromagnet 58 of the brake unit D is powered to cause the iron plate56 to separate from the adjacent brake lining 54, so the brake unit D releases the brake force on the drive unit B. In other words, in the electric operation mode of the door operator 1 of the present invention, the brake unit D is released due to the power-on, thereby releasing the brake force of the brake unit D on the drive unit B. The drive unit B is configured to generate rotational inertia (not shown), the rotational inertia is transferred to the output unit A through the transmission unit C, so that the door is moved through the output unit A. At this time, in the brake unit D of the door operator 1, only the brake disc 52 and the brake lining 54 provided thereon rotate due to the rotation of the driving shaft 20 of the drive unit B. Meanwhile, remaining parts of the brake unit D and the manual chain unit E do not move and remain relatively stationary.

In addition, if the door operator 1 of the present invention encounters an emergency situation such as a power outage or malfunction and needs to switch to a manual operation mode under the situation of the power outage or the power cut off, the electromagnet 58 of the brake unit D is not powered at this time so that the iron plate 56 of the brake unit D abuts the adjacent braking disc 52 and the brake lining 54 due to the elastic force of the annular spring 60. At this time, there is brake force at the interface between the brake unit D and the drive unit B. Accordingly, the operator (not shown) can perform the manual operation by first pulling the manual chain 84 to rotate the rotary disc 78, and then sequentially rotate the sprockets 80 and 82 connected by the chain 86 and the engage gears 64 and 76 through the rotational inertia generated by the rotation of the rotary disc 78. The rotation of the gear 64 further drives the rotation of the electromagnet shaft 50 and the iron plate 56 of the brake unit D. At this time, since there is the brake force at the interface between the brake unit D and the drive unit B, the rotational inertia from the electromagnet shaft 50 and the iron plate 56 of the brake unit D can then be transferred to the drive unit B to rotate the driving shaft 20 through the connected brake disc 52 and the braking lining 54, and then the rotational inertia is further transferred to the transmission unit C through the rotation of the driving shaft 20, thereby rotating the output shaft 10 through rotation of the rotating shaft 30 and the sprockets 32 and 14 connecting the chain 40 of the transmission unit C, thereby achieving the purpose of moving the door (not shown) in the manual operation mode. In other words, the manual chain unit E is configured to generate rotational inertia (not shown), and the rotational inertia can arrive the output unit A through the transfer of the brake unit D, the drive unit B and the transmission unit C in sequence, thereby moving a door (not shown) through the output unit A.

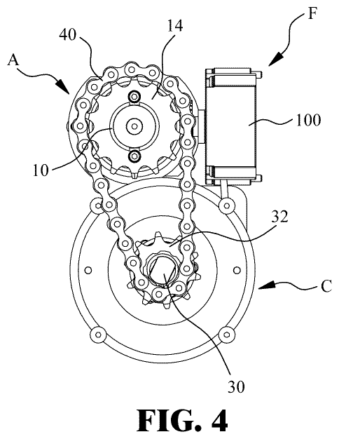

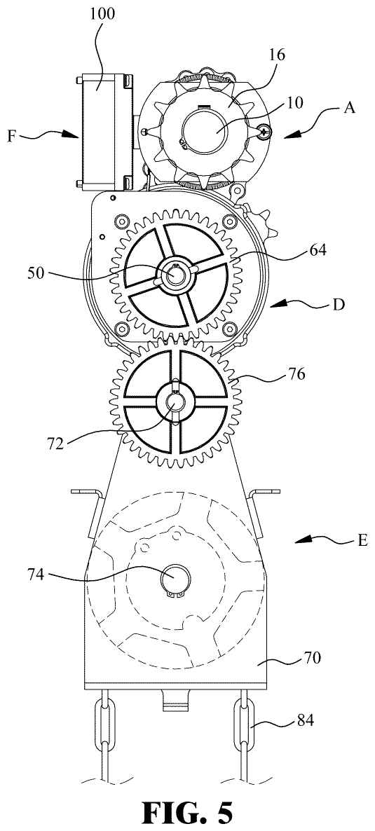

Please refer to the schematic side views of FIG. 4 and FIG. 5. FIG. 4 shows a schematic side view of the transmission unit C of the door operator 1 capable of manual operation of FIG. 2 of the present invention. FIG. 5 shows a schematic side view of the brake unit D of the door operator 1 of FIG. 2 of the present invention. In FIG. 4 and FIG. 5, the same reference numerals represent the same components, and their implementation details will not be described in detail here.

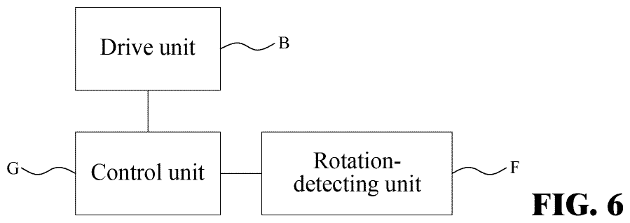

FIG. 6 shows a system schematic diagram of a door operator 1 capable of manual operations according to an embodiment of the present invention. In addition to the drive unit B and the rotation-detecting unit F, the door operator 1 further comprises a control unit G (not shown in FIGS. 1 to 3), thereby realizing the control of multi-functional operations such as the manual operation and the electric operation of the door operator 1. To further explain, the drive unit B and the rotation-detecting unit F are electrically connected to the control unit G. Regardless of whether the door operator 1 is in the electric operation mode or the manual operation mode, the control unit G can control the rotation-detecting unit F to detect whether the output shaft 10 of the output unit A rotates or not. When the door operator 1 is in the manual operation state and the operator operates the manual chain 84 to cause the output shaft 10 of the door operator 1 to rotate, after the sensing device 100 of the rotation-detecting unit F senses rotation of the shaft 10, the control unit G will prohibit the electric operation of the door operator 1 for safety and emit buzzer sounds to remind the door operator 1 that it is in the manual operation mode and thereby prevent the operator from being injured or the system from be damaged, so as to avoid accidents and improve the operating efficiency of the door operator.

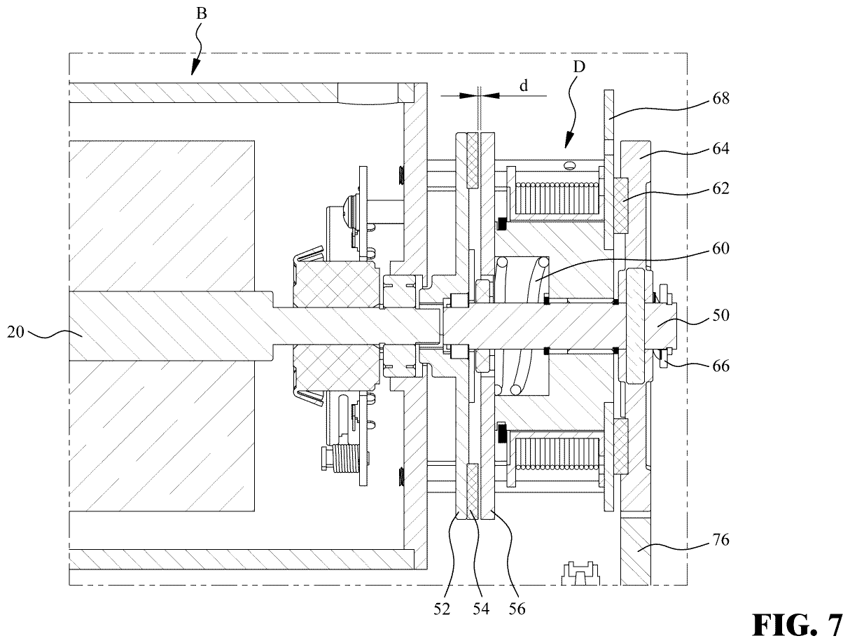

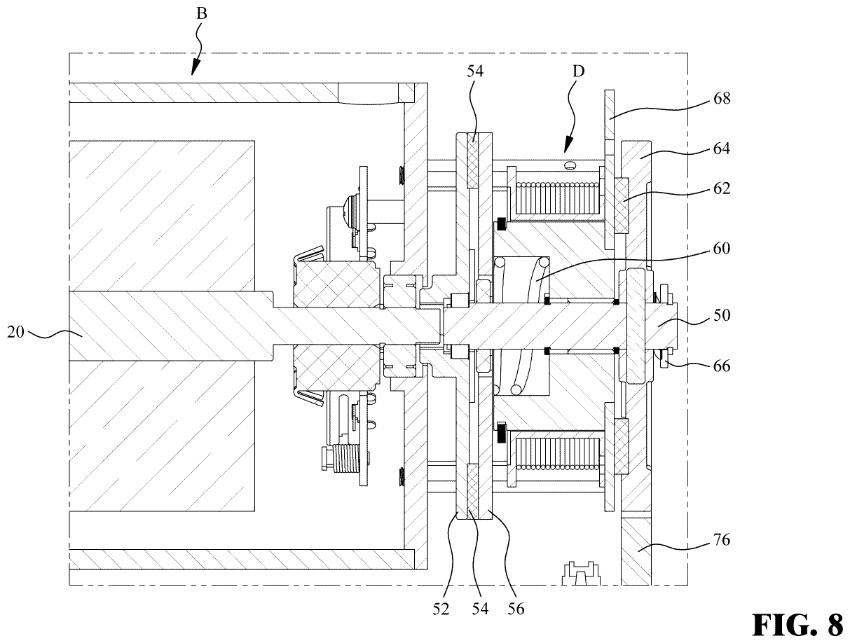

Please refer to FIGS. 7-8, which further illustrates a schematic diagram of an area Z in the door operator 1 capable of manual operations of the present invention in FIG. 1 in the electric operation mode and the manual operation mode. Same as the above-mentioned situations shown in FIGS. 1 to 3 and related descriptions, in short, in the door operator 1 capable of manual operations of the present invention, the brake unit D and the manual chain unit E provide the manual operation function of the door operator 1.

FIG. 7 shows a schematic diagram in the electric operation mode. In the electric operation mode, when the brake unit D is released, a gap d is formed between the iron plate 56 and the adjacent brake lining 54, and the power is output through the drive unit B to drive the chain 40 to rotate the output shaft 10 to move the door at the same time. In the electric operation mode, the brake unit D and the manual chain unit E do not move and remain stationary. In one embodiment, the gap d is, for example, 0.2-0.6 millimeters (mm).

FIG. 8 shows a schematic diagram in manual operation mode. The braking unit D adopts a brake design of two-stage braking linings. As described above, in the manual operation mode, when the electromagnet 58 of the braking unit D is under power outage or not powered, the annular spring 60 can cause the iron plate 56 to abuts the adjacent brake disk 52 and the brake lining 54, thereby providing a first braking force at the interface between the braking unit D and the driving unit B. Meanwhile, the brake lining 62 between the gear 64 and the electromagnet mounting bracket 68 still maintains a continuous braking state, thereby providing a second braking force between the gear 64 and the electromagnet mounting bracket 68. Therefore, the rotational inertia of the electromagnet shaft 50 of the braking unit D caused by the rotation of the gear 64 can be transferred through the drive unit B and the transmission unit C to rotate the output shaft 10 of the output unit A through the chain 40, thereby achieving the purpose of moving the door (not shown).

Accordingly, when the door operator capable of manual operations of the present invention encounters an emergency situation, a door can be immediately move through a manual operating module, without the need for additional operating steps or component settings. Since there is no need for additional operating steps or component settings for manual operations, so the door operator capable of manual operations of the present invention can immediately and directly switch from the manual operation mode to the electric operation mode without any problem when the emergency situation is resolved without causing injuries to operators or damage to the system, thereby avoiding accidents and improving the operating efficiency of the door operator.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

What is claimed is:

1. A door operator capable of manual operations, comprising:
an output unit, a drive unit, a transmission unit, a brake unit, and a manual chain unit, wherein the drive unit is disposed between the transmission unit and the brake unit, the output unit is disposed on a first side of the drive unit, the transmission unit, and the brake unit, and the manual chain unit is disposed on a second side of the drive unit, the transmission unit, and the brake unit that is opposite to the first side,
wherein, during a manual operation mode, the brake unit provides a brake force on the drive unit and the manual chain unit is configured to generate rotational inertia, and the rotational inertia is transferred to the output unit via the brake unit, the drive unit and the transmission unit.

2. The door operator capable of manual operations of claim 1, wherein, during an electric operation mode, the brake unit is powered so as to release the brake force on the drive unit, and the drive unit is configured to generate another rotational inertia, and the another rotational inertia is transferred to the output unit via the transmission unit.

3. The door operator capable of manual operations of claim 1, further comprising a rotation-detecting unit, wherein the rotation-detecting unit is configured to connect the output unit via a plurality of gears to detect whether the output unit rotates.

4. The door operator capable of manual operations of claim 3, wherein the rotation-detecting unit comprises a sensing device, and the sensing device comprises a sensing element for detecting rotation.

5. The door operator capable of manual operations of claim 4, wherein the sensing element is an optical encoder, a magnetic induction encoder, a mechanical limit structure cooperating with a photoelectric switch, or a Hall effect sensor.

6. The door operator capable of manual operations of claim 2, wherein the brake unit is an electromagnetic brake unit.

7. The door operator capable of manual operations of claim 6, wherein the electromagnetic brake unit comprises a brake disc, an electromagnet shaft, an iron plate, an electromagnet, an annular spring, a wave washer, a first brake lining and an electromagnet mounting bracket,
wherein the wave washer is disposed around the electromagnet shaft, and the first brake lining is adhered to a surface of the brake disc facing the iron plate,
wherein, during the manual operation mode, the electromagnet of the brake unit is under power outage or is not powered so that the magnetic disc abuts the brake disc and the first brake lining, thereby providing a first brake force at an interface between the brake unit and the drive unit so that the rotational inertia is transferred to the output unit via the brake unit, the drive unit and the transmission unit.

8. The door operator capable of manual operations of claim 7, wherein during the electric operation mode, the electromagnet of the brake unit is powered so as to separate from the adjacent first brake lining and release the first brake force on the drive unit.

9. The door operator capable of manual operations of claim 8, wherein, during the electric operation mode, a gap is formed between the magnet disk of the electromagnetic brake unit and the first brake lining.

10. The door operator capable of manual operations of claim 6, wherein the brake unit further comprises a gear and a second brake lining, and the second brake lining is disposed between the gear and the electromagnet mounting bracket and is adhered to the gear, thereby providing a second brake force at an interface between the gear and the electromagnet mounting bracket.
